(19) United States
(12) Patent Application Publication
(10) Pub. No.: US 2024/0296550 A1
(43) Pub. Date: Sep. 5, 2024

(54) High Speed Detection of Anomalies in Medical Scopes and the Like Using Image Segmentation

(71) Applicant: BH2 Innovations Inc., Newbury Park, CA (US)

(72) Inventors: Salmaan Hameed, San Jose, CA (US); Harut Margaryan, Yerevan (AM)

(21) Appl. No.: 18/116,608

(22) Filed: Mar. 2, 2023

(51) Int. Cl. G06T 7/00; G06T 5/20; G06T 7/11; G06T 7/12; G06T 11/00; G06V 20/40; G06V 20/70; H04N 7/18; H04N 23/50

(52) U.S. Cl. CPC G06T 7/0012; G06T 5/20; G06T 7/11; G06T 7/12; G06T 11/00; G06V 20/40; G06V 20/70; H04N 7/183; H04N 23/555; G06T 2207/10016; G06T 2207/20028; G06T 2207/20081; G06T 2207/20084; G06T 2207/30004; G06V 2201/034

(57) ABSTRACT

An artificial intelligence (AI) image recognition system can detect and recognize surface anomalies along a channel of a medical scope. The system includes image processing deep learning modules configured to process image data from an image sensor of a digital borescope. The image processing modules include a convolutional neural network trained on a data set of images of surface anomalies present along surfaces of channels of medical scopes, and the convolutional neural network is configured for semantic segmentation. The presence and instances of the surfaces of the anomalies can be predicted in real time as the digital borescope is pushed through the channel of the medical scope. Indicia of the type and/or instances of occurrence of the surface anomalies along the channel can be displayed in a time neutral manner with respect to the digital video output by a borescope.

### FIELD

The present disclosure pertains to medical scopes such as endoscopes and the like. In particular, the present disclosure pertains to the inspection of channels of medical scopes to detect sources of contamination, structural defects, etc.

The present disclosure also pertains to image analysis and recognition using artificial intelligence. In particular, the present disclosure also pertains to semantic segmentation using deep learning for real time detection and recognition of edge boundaries and shapes in images.

### DESCRIPTION OF RELATED ART

Rigid and flexible videoscopes are used in a wide array of industries to provide visual access to regions deep inside pieces of equipment. Chief among these industries is the field of internal medicine. Crucial to this field are medical scopes used to provide images of internal parts of the body for screening and making medical diagnoses, and which may additionally allow for therapeutic treatments to be carried out. With respect to the latter, medical scopes may have narrow working channels or “lumens” for containing accessories (medical instruments or manipulators) used to carry out procedures in minor surgeries. For example, endoscopes are a class of devices that allow parts of the body such as the colon (colonoscope), bladder (cystoscope), kidneys (nephroscope), bronchial tubes (bronchoscope), joints (arthroscope), thorax (thoracoscope), or abdomen (laparoscope) to be observed and treated, if necessary, in a minimally invasive way. Examples of the accessories that may be inserted into the body through working channels of endoscopes are forceps for conducting biopsies or removing polyps during a colonoscopy, electrodes for cauterizing tissue, cytology brushes to collect cells from the bronchi or gastrointestinal tract, aspiration needles for conducting biopsies, and instruments for placing elastic bands around bleeding veins (banding of esophageal varices).

Thus, although endoscopes vary widely in structure, they share some basic components. Specifically, and referring to FIGS. 1A and 1B, an endoscope 100 will typically include an insertion tube 110 (in this example, a flexible insertion tube) that is inserted through an opening in the body, a control section 120 to which the insertion tube 110 is connected and by which various parts of the endoscope 100 are controlled by the operator, a connector section 130 connected to the control section 120 for connecting various external devices to the endoscope 100 and an optical system generally designated by reference numeral 140.

The optical system 140 is composed of a light guide extending through the insertion tube 110 to a distal end 110a of the insertion tube 110 and connected to a light source for illuminating the region of interest inside the body, and an image guide (not shown) extending through the insertion tube 110 to an objective lens 112 at the distal end 110a. The objective lens 112 captures light from the illuminated region of interest and focuses the light back onto the image guide for producing an image of the region of interest. The light and image guides may be made up of fiberoptics only a few millimeters in diameter to transfer illumination from the light source in one direction and images in real time in the other direction. The light source is not shown as it is typically not part of the scope itself. Likewise, although some endoscopes include an eyepiece optically connected to the image guide and through which the images of the region of interest can be viewed, in this example the connector section 130 is connected to a display upon which the images of the region of interest can be viewed.

Still referring to FIGS. 1A and 1B, the insertion tube 110 further includes an instrument channel 114 into which one of the accessories may be inserted and withdrawn by way of a channel opening 116 in the insertion tube 110. The instrument channel 114 is a narrow duct surrounded by opaque material of the insertion tube 110. Other working channels in the insertion tube may include an air/water pipe(s) 116 for use in providing air, suction and/or irrigation to the region of interest.

Since the components and features of medical scopes such as endoscopes are generally well-known in the art, the example shown in FIGS. 1A and 1B will not be described in further detail for the sake of brevity.

The insertion tubes of medical scopes may contact a source of contamination such as a mucous membrane during a clinical procedure. Accordingly, medical scopes are potential sources of infection during subsequent uses. Therefore, at the conclusion of each use, medical scopes are “reprocessed” in an attempt to eliminate all microorganisms from the scopes. The microorganisms may reside in stains and droplets of moisture, blood, lubricant, etc. along a channel of the scope. The reprocessing of endoscopes basically includes a manual washing process, a high-level disinfecting (HLD) process carried out with a liquid chemical germicide, and a drying process during which the scope is hung in storage for some period of time. The manual washing process is typically an enzymatic cleaning process.

Medical scopes may also suffer occult damage during use and/or over time. For example, the surface defining the instrument channel of the scope may be scratched as an instrument is inserted or withdrawn along the channel and especially along a curved portion of the channel. The layer of material that defines the channel within the insertion tube may exhibit peeling. Both of these types of defects provide locations at which debris may reside and harbor microbes and where the efforts of reprocessing to remove the debris is resisted. And in flexible scopes in particular, the insertion tube may be bent or even bitten by a patient to such an extent as to crimp or buckle the instrument channel. This not only increases the likelihood of scratching or peeling (at the location of the crimp) but may give rise to mechanical breakdown of the scope. In some cases, the crimping or buckling causes operational failure during a clinical procedure with resulting serious harm to the patient undergoing the procedure.

Because mechanical breakdown and infections have been linked to occult damage, droplets and other residue remaining in the channel, it is standardized practice to inspect endoscopes frequently for these and other types of “surface anomalies” in the channels. Results of the inspection process are used for quality assurance and risk management and infection control. Specifically, the inspection process is used to determine whether the medical scope must be reprocessed again, sent out for repairs or even discarded as being at the end of its useful life. Industry standards and guidelines from manufacturers of endoscopes recommend the use of borescopes for this purpose. A borescope is an optical tool at the end of either a rigid or flexible tube and similarly to an endoscope, constitutes a remote visual inspection device.

Referring to FIG. 2, a typical digital borescope 200 for use in inspecting the narrow channels of medical scopes, such as instrument channel 114 of the endoscope 100 shown in FIGS. 1A and 1B, has a light guide 212 extending through the tube to a light source for illuminating the channel when in use, an image sensor 214, an objective 216 for focusing light onto the image sensor 214, and a signal line (bus) 218 for transmitting video signals (digital image data) output by the image sensor 214. The video signals are processed into images of the channel and displayed on the display of a custom or computer monitor, smartphone, etc. connected to signal line 218. The image sensor of the borescope 200 comprises a CMOS device provided on a chip. Due to size constraints dictated by the narrowness of the channel of the medical scope being inspected, the pixel array of the CMOS device may have no more than 1600 pixels, e.g., may be a 200×200 or 400×400 array. Thus, borescope 200 may produce only standard definition as opposed to high definition (HD) images.

The inspections of medical scopes may be carried out in the facility in which the scopes are used, e.g., the sterilizing, processing and disinfecting department (SPD) of a hospital or clinic, or even at a repair facility to assess the results of the repair process. As reported by C. L. Ofstead et al. in the American Journal of Infection Control 51 (2023) 2-10, manufacturers of endoscopes have not yet provided “guidance on how to perform borescope examinations and discern whether findings are normal or represent defects that require repair, additional cleaning, or other action.” In addition, as mentioned above, borescopes used to image the narrow channels of medical scopes may produce only relatively low-resolution images.

Therefore, the personnel (e.g., endoscopists) who are charged with visually inspecting and real time evaluation of medical scopes using a borescope require highly specialized training individualized throughout even similar departments or facilities. Nonetheless, the inspection process has a degree of uncertainty based on human error inherent in the inspection process. To minimize human error, such personnel must push a borescope slowly through the channel of a medical scope, i.e., to ensure that they do not overlook and are capable of identifying surface anomalies that require further attention.

Furthermore, facilities such as large hospitals may carry out scores of procedures using medical scopes on daily basis. The time and hence, labor costs, required to inspect these scopes periodically and especially after each use as recommended is thus enormous.

Artificial intelligence (AI) is a developing technology in the field of image recognition and has been used to detect boundaries of features or objects in digital images and recognize the features or objects from the boundaries. A goal of applying AI-based technology to the inspection of channels of medical scopes would be to minimize human error with the ultimate goal being unsupervised medical scope evaluations.

One “proof of concept” study by Barakat et al. at Stanford Medical Hospital showed promise for the ability of AI technology to recognize the presence of surface anomalies like scratches, peeling, and droplets, in images of channels of endoscopes. This study was performed using an object detection model of localizing the surface anomalies in bounding boxes, respectively, and identifying each anomaly in its bounding box. However, the object detection model used in this study has various shortcomings: the model is rather incapable of detecting very fine surface anomalies (high sensitivity), characterizing surface anomalies with a high degree of specificity, and ensuring reliable predictive power (accuracy) for different scopes. Predictions would also have to provide for an assessment of the severity of the anomalies, both individually and collectively. Furthermore, handling the speed at which a borescope could be pushed through a channel of a medical scope when attempting to carry out inspections rapidly would also require the images of the borescope to be processed at a high speed to ensure that surface anomalies were detected with the necessary degree of quality assurance.

However, providing many or all of these requirements is either unsurmountable through the use of conventional AI image-recognition techniques such as those based on object detection, or requires high computational power resulting in an expectedly low corresponding processing speed.

Therefore, there remains a need for improved methods and systems that can detect anomalies along a channel of a medical scope at a relatively high speed and, in particular, without sacrificing other advantages such as sensitivity and reliability. Similarly, there remains a need for AI image recognition methods and systems capable of rapidly detecting anomalies along a channel of a medical scope in real time, and even as quickly as a digital borescope can be pushed by a technician or device along the channel.

### SUMMARY

According to one aspect of the disclosed technology, there is provided a method of detecting anomalies along a channel of a medical scope. The method includes accessing, at an artificial intelligence (AI) image recognition system including a deep learning tool, image data produced by a digital borescope as the borescope is pushed along a length of a channel of a medical scope, predicting in real time as the digital borescope is pushed through the channel of the medical scope, the presence of one or more types of anomalies at locations along the length channel, and providing an output of indicia of surface anomalies along the length of the channel. The image data produced from pixels of an image sensor of the borescope is using the deep learning tool including by a convolutional neural network trained on a data set of images of surface anomalies along channels of medical scopes of a kind like that through which the borescope is pushed. The convolutional neural network is configured for semantic segmentation. The semantic segmentation occurs along only a context path in the AI image recognition system once the image data is accessed by the system.

According to a similar aspect, there is provided a method for use in evaluating medical scopes, including pushing a digital borescope along a length of a channel of a medical scope to capture images of the channel and output image data representative of the images, transmitting image data from each of pixels of an image sensor of the digital borescope to an artificial intelligence (AI) image recognition system including a deep learning tool to predict the presence of at least one type of anomaly at locations along the length channel of the medical scope, and analyzing indicia of anomalies along the channel from output of the image recognition system. The deep learning tool has a convolutional neural network trained on a data set of images of surface anomalies along channels of medical scopes of a kind like that through which the borescope is being pushed. The deep learning tool is configured for semantic segmentation and to process in real time image data produced from pixels of an image sensor of the borescope, and the AI image recognition system is configured to output indicia of surface anomalies along the length of the channel based on results of the processing of the image data by its deep learning tool. The semantic segmentation is carried out along only a context path in the AI image recognition system.

According to yet another similar aspect, there is provided an artificial intelligence (AI) image recognition system for use in detection of surface anomalies along a channel of a medical scope. The system includes a video input output (I/O) operative to receive data of video images, image processing deep learning modules operatively connected to the video input output (I/O) to receive data of video images therefrom, and a graphics output module including a video input output (I/O) operatively connected to the image processing modules to receive results of the processing of data of video images by the image processing modules and output the results. The deep learning modules are configured to process image data produced from an image sensor of a digital borescope, and include a convolutional neural network trained on a data set of images of surface anomalies present along a surface of channels of medical scopes and configured for semantic segmentation. The convolutional neural network is configured for semantic segmentation along only a context path once data of video images is output from the video I/O and received by the deep learning modules.

The use of a context path only for the semantic segmentation allows for especially high-speed processing of the video image data produced by a borescope without loss in detection accuracy, when applied to recognizing surface anomalies along the channels of medical scopes. Exemplary of this speed is a rate of about 0.03 seconds per frame.

### BRIEF DESCRIPTION OF THE DRAWINGS

These and other objects, features and advantages of the present technology will be better understood from the detailed description of preferred embodiments and examples thereof that follows with reference to the accompanying drawings, in which:

FIG. 1A is a perspective view of an example of a medical scope to which the present technology can be applied;

FIG. 1B is an enlarged view of a distal end of an insertion tube of the medical scope;

FIG. 2 is a cross-sectional view of an example of a borescope to which the present technology can be applied;

FIG. 3 is a schematic diagram of an example of a network including an artificial intelligence (AI) image recognition system according to the present technology;

FIG. 4 is a block diagram of a portion the deep learning tool of the (AI) image recognition system of FIG. 3, with associated representations of image frames produced as a result of processing by modules and algorithms of the deep learning tool;

FIG. 5 is a schematic diagram of an Image Enhancement module of the deep learning tool;

FIG. 6A is a schematic diagram of real-time semantic segmentation network architecture of the AI image recognition system of FIG. 3;

FIG. 6B is a schematic diagram of the attention refinement module of the of the semantic segmentation network architecture;

FIG. 7 is a schematic diagram of an example of the backbone of the semantic segmentation network architecture shown in FIGS. 6A and 6B;

FIG. 8 is a process flow diagram of an example of a method of detecting anomalies along a channel of a medical scope according to the present technology; and

FIGS. 9A, 9B, 9C, 9D, 9E and 9F are each a pairs of images, one being an actual original image of the instrument channel of an endoscope captured by a digital borescope and the other being an image containing indicia of surface anomalies derived from the original image using an embodiment of the present technology as shown and described with reference to FIGS. 1-8.

### DETAILED DESCRIPTION

Embodiments of the present technology and examples thereof will now be described more fully in detail hereinafter with reference to the accompanying drawings. In the drawings, elements may be shown schematically for ease of understanding. Also, like numerals and reference characters are used to designate like elements throughout the drawings.

Certain examples may be described and illustrated in terms of blocks which carry out a described function or functions. These blocks, which may be referred to herein as modules or the like, are physically implemented by analog and/or digital circuits such as logic gates, integrated circuits, microprocessors, microcontrollers, memory circuits, passive electronic components, active electronic components, optical components, hardwired circuits and the like, and may be driven by firmware and/or software of non-transitory computer readable media (CRM). In the present disclosure, the term non-transitory computer readable medium (CRM) refers to any medium that stores data in a machine-readable format for short periods or in the presence of power such as a memory device or Random Access Memory (RAM). The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the examples may be physically separated into two or more interacting and discrete blocks and conversely, the blocks of the examples may be physically combined into more complex blocks while still providing the essential functions of the present technology.

The terminology used herein for the purpose of describing particular embodiments of the present technology is to be taken in context. For example, the term “comprises” or “comprising” when used in this disclosure indicates the presence of stated features or steps in a process but does not preclude the presence of additional features or steps. The term “about 1600 pixels” is to be understood as referring to pixel numbers of an array that can output standard definition (SD) as opposed to high-definition (HD) images. Standard definition images are generally understood in the art as no more than (480p) and thus, the term no more than 1600 pixels may refer to 400×400 or 200×200 pixel arrays. The term “about 0.03 seconds per frame” is used to encompass the practical working range of high speeds at which the disclosed examples of a deep learning tool according to the present technology can process the described video input data and output image recognitions results. Therefore, the term “at most about 0.03 seconds per frame” encompasses all practical higher speeds. The term “context path” is a term of art understood as a path along which global context information as distinguished from spatial information (information about spatially proximate pixels) is transcribed onto feature masks.

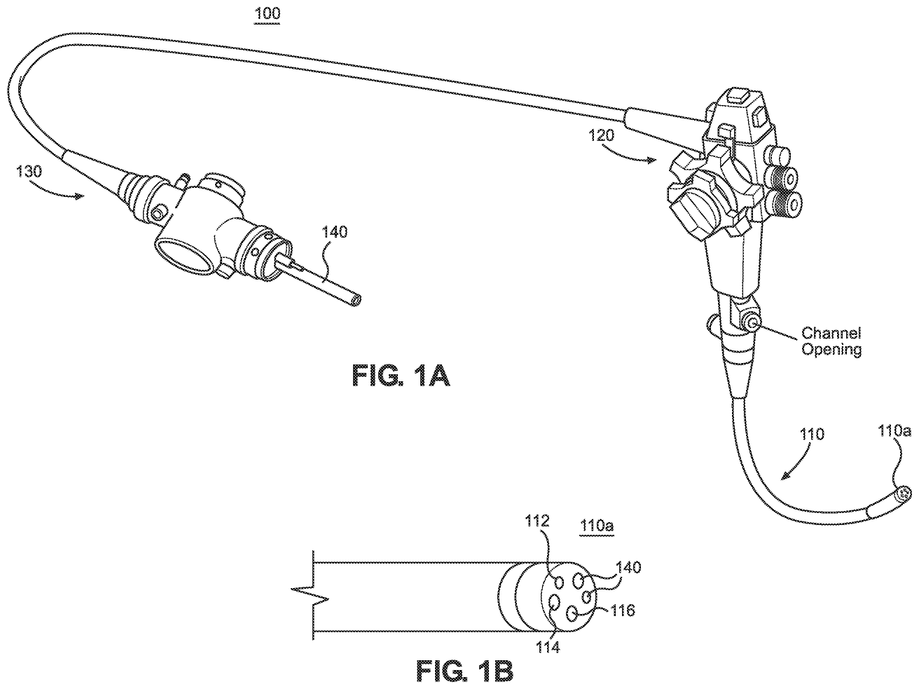

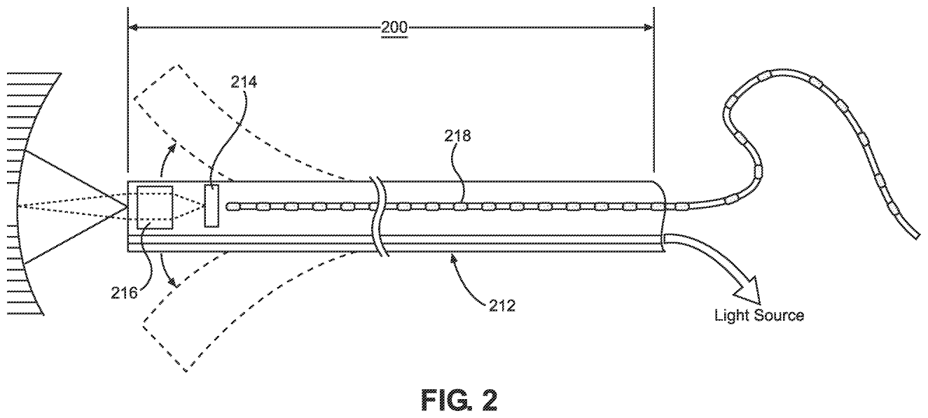

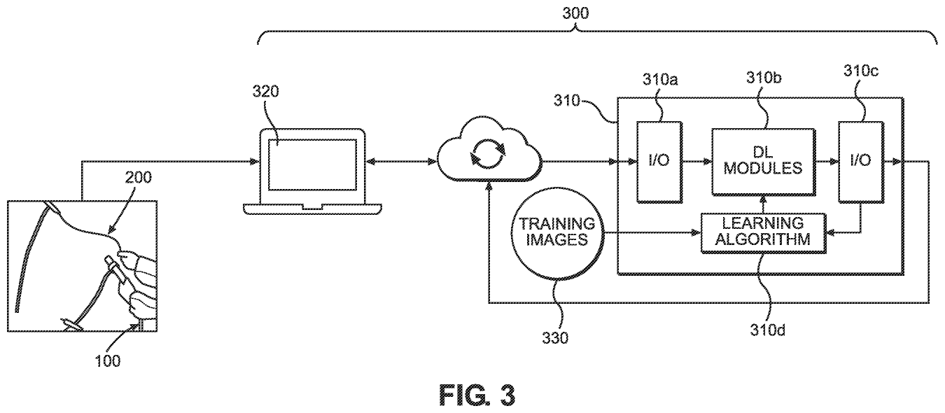

FIG. 3 illustrates a system or network in which surface anomalies along a channel of a medical scope are detected. The block at the left-hand side of FIG. 3 represents an environment, such as an SPD of a hospital, in which a medical scope 100 is inspected by a technician, e.g., a trained endoscopist, using a digital borescope 200 (FIGS. 1A, 1B and 2). An artificial intelligence (AI) image recognition system 300 may be operatively connected to the digital borescope 200 for real time detection of anomalies along a channel, e.g., an instrument channel, of the medical scope 100.

The AI image recognition system 300 includes a deep learning tool 310 and may also include a visual display unit 320 (typically, an LCD as a standalone or part of a computer such as a desktop or laptop). The visual display unit 320 may have a graphical user interface (GUI) by which a user of the present technology may call up images and indicia of surface anomalies output by the deep learning tool 310. The AI image recognition system 300 may be part of an enterprise system in which the components are connected to form a local area network (LAN) or carried out over the internet to provide a Service as a Service (SaaS). Therefore, the deep learning tool 310 may be provided on a server or the like, accessed by means of the web (as shown) or by an ethernet cable, router or hub, etc. Instructions for operating system AI image recognition system 300 including executing processes of the deep learning tool 310 are provided on non-transitory computer readable media (CRM).

The deep learning tool 310 comprises a graphics processor unit (GPU), i.e., a specialized processor. The deep learning tool 310 may also include associated memory and a CPU for executing algorithms in the AI image recognition system 300. The GPU of deep learning tool 310 is exemplified as including a digital video input output (I/O) 310a, deep learning modules 310b operatively connected to the digital video I/O 310a, and a graphics module (I/O) 310c operatively connected to the deep learning modules 310b. The deep learning tool 310 also has a training module 310d having an associated memory device(s) and is configured with a deep learning algorithm for supervised or semi-supervised training of the network implementing the deep learning modules 310b. In this example, deep learning module 310d is operatively connected to a memory 330 for storing data sets of training images, namely, images of channels of medical scopes including surface anomalies. The memory 330 may be separate from or an integral part of the deep learning tool 310. In an example of the present technology, the deep learning modules 310b comprise a residual learning framework and thus, are configured for residual learning. The digital video I/O 310a may comprise a digital video interface (DVI) or any type of video interface that can receive RGB video signals of image frames captured by the image sensor 214 of the digital borescope 200 and output the signals to the specialized GPU 310b. The graphics output module 310c may comprise a digital video I/O such as a digital video interface (DVI) or any known type of video interface that can receive video image signals from the specialized GPU 310b and a graphic generator that can generate graphics data from the image signals. The graphics output module 310c outputs the signals of the images produced by the GPU constituting the deep learning tool 310, along with indicia of the surface anomalies to the visual display unit 320.

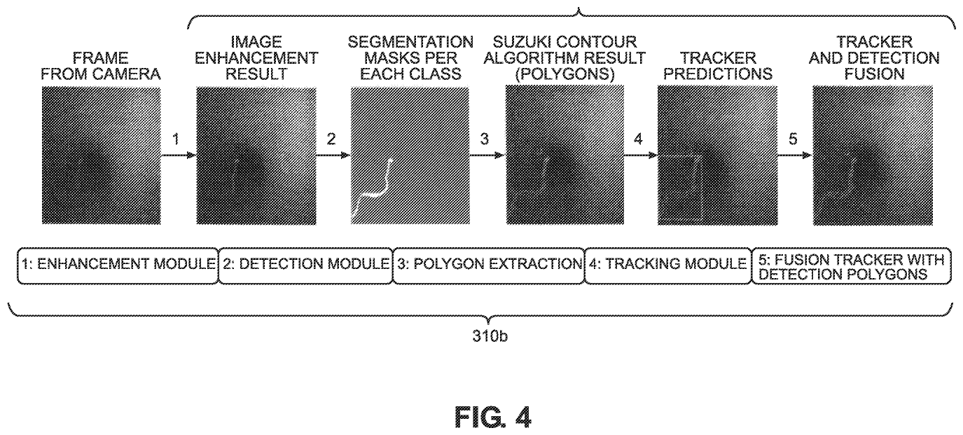

The deep learning modules 310b, and the algorithms executed on outputs produced therefrom, will be described in more detail with reference to FIG. 4. In the description that follows, for simplicity the term “image” or “video” may at times be used to refer to digital data representative of the image or video. Also, in FIG. 4, a representative image frame from image sensor 214 of the digital borescope 200 (“Frame from camera”), showing a surface anomaly (scratch) along the channel of the medical scope 100, is used for purposes of description but the same description applies to detecting and recognizing other types of surface anomalies according to the present technology.

As mentioned above, the image data from the pixels of the image sensor 214 (RGB color images) may be in standard definition format. The image data is input to the deep learning modules 310b by way of video I/O 310a. The image can be processed by the deep learning modules 310b at a rate as high as 0.03 frames per second, whereas humans require ¼ of a second to process one such image frame by eye. Or, put another way, the deep learning modules 310 configured according to the present technology can process an image captured by a digital borescope in no more than 30 milliseconds.

To this end, according to one embodiment of the present technology, the deep learning modules 310b comprise an image Enhancement module, a Detection module, and a Tracking Module and a Polygon extraction module, and a processor constituting modules for executing a Polygon extraction algorithm and a data Fusing algorithm. These modules/algorithms are described in detail below.

### 1: Enhancement Module

The image Enhancement module is configured to enhance the RGB color images produced by the digital borescope 200 to emphasize any surface anomaly in the images. In an embodiment of the present technology, the Image enhancement module comprises a digital filter selected to transform the images captured by the borescope 200, and accessed by the deep learning tool 310 through its digital video I/O 310a, into enhanced images. In one example, the Image enhancement module consists of a Bilateral filter for image smoothing, followed by a 2Dfilter for image sharpening, and finally a second Bilateral filter for image smoothing. Suitable examples of the 2D and Bilateral filters may be selected from those available in the open source computer vision library (OpenCV library), essential features of which are provided below.

### 2DFilter

A suitable example of the digital filter is a 2Dfilter is characterized by the following parameters, filter coefficients and correlation function:

### Parameters

src input image.
dst output image of the same size and the same number of channels as src.
ddepth desired depth of the destination image.
kernel correlation kernel, a single-channel floating point matrix for the RGB channel
anchor anchor of the kernel that indicates the relative position of a filtered point within the kernel; the anchor should lie within the kernel; default value (−1,−1) means that the anchor is at the kernel center.
delta optional value added to the filtered pixels before storing them in dst.
Programming in Python, Input array (src), Output Array (dst), Input Array (kernel), and Point (anchor)
cv.filter2D (src, ddepth, kernel[, dst[, anchor[, delta[,borderType]]]]->dst, and Correlation function
   dst(x,y)=Σ0≤x′<kernel.cols0≤y′<kernel.rowskernel(x′,y′)*src(x+x′-anchor.x,y+y′-anchor.y)

The function may use the direct algorithm for small kernels.

### Bilateral Filter

Bilateral filtering is applied to the original image and then again to the image sharpened by the 2DFilter to suppress noise in the images. The concept behind bilateral filtering is described in detail on the homepage for the university of Edinburgh, School of Informatics, titled, “Bilateral Filtering For Gray and Color Images.”

A suitable example for each of the Bilateral filters is characterized by the following parameters and filter coefficients:
src floating-point, 3-channel image.
dst Destination image of the same size and type as src.
d Diameter of each pixel neighborhood that is used during filtering, computed from sigmaSpace.
sigmaColor Filter sigma in the color space.
signaSpace Filter sigma in the coordinate space.
borderType border mode used to extrapolate pixels outside of the image.

### Programming in Python

cv.bilateralFilter(src, d, sigmaColor, sigmaSpace[, dst[, borderType]])->dst

### 2: Detection Module

The Detection module has a convolutional neural network configured to apply a semantic segmentation process to the enhanced image output from the Enhancement module. In general, the input channel is the enhanced RGB image and has pixels correlating to those of the image output by the image sensor 214 of borescope 200. The Detection module assigns semantic labels (sematic context information) to pixels of the enhanced image. More specifically, the Detection module produces a (binary) semantic segmentation mask for each of several classes of surface anomalies, so that the pixels in each of the segmentation masks are encoded with binary data correlated with each class of surface anomaly. In the present embodiment, there are five (5) distinct classes of surface anomalies: droplet, peeling, crimp, scratch and stain. Therefore, in this example, the output of the Detection module is a binary mask with five (5) channels. Surface anomalies and parts thereof may be referred to hereinafter as “objects”.

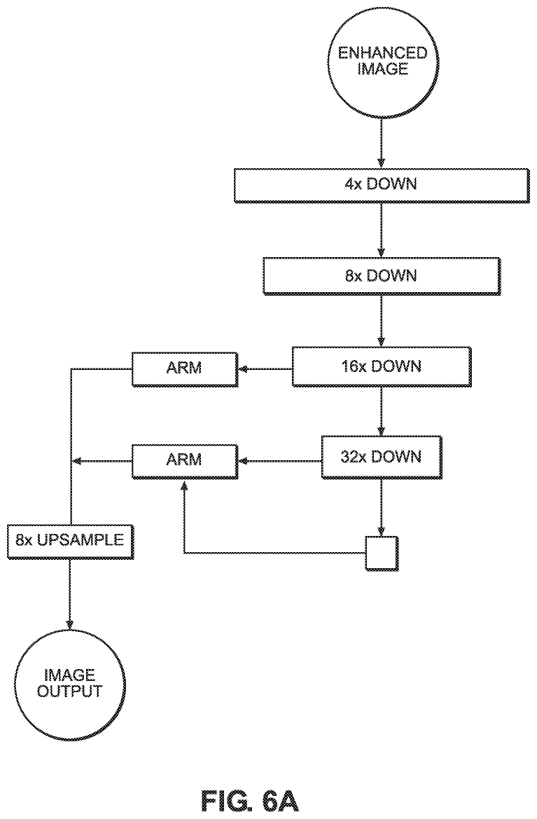

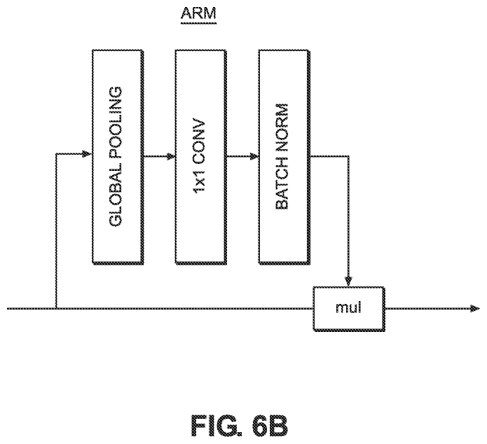

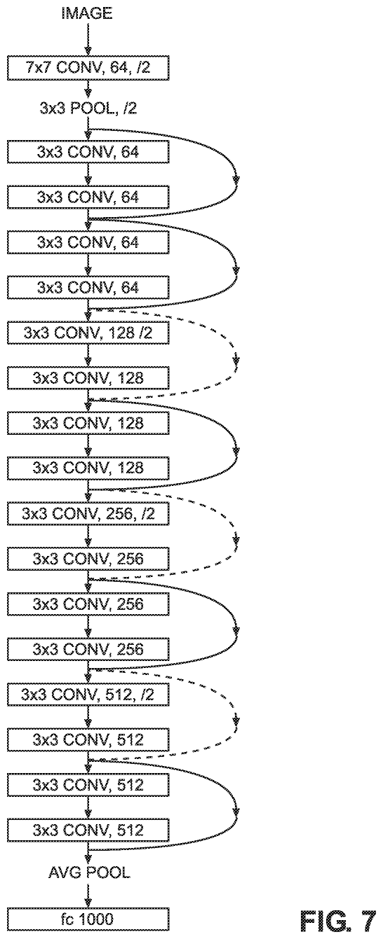

FIGS. 6A, 6B and 7 constitute a workflow diagram of the Detection module, with FIGS. 6A and 6B showing the workflow and FIG. 7 showing an example of the backbone of the network architecture by which the Detection module is implemented. The network architecture of the Detection module requires the highest computational power in the deep learning tool 310. The architecture of this example is designed to minimize the computational power and facilitate the high-speed processing by the deep learning tool 310. According to the present technology, the standard definition images output by a borescope as it is pushed rapidly through a channel of a conventional medical scope can be processed at a rate of about 0.03 seconds per image frame or less, without loss in ability to accurately predict and identify surface anomalies along the channel.

As can be seen from FIGS. 6A and 6B, the process is an end-to-end process having only relatively narrow channels with deep layers to encode semantic labels to a receptive field, namely, the region in the enhanced image that has an object. There is no encoding of spatial information, i.e., information of the relative position (distance and orientation) of pairs of pixels in the output of the Enhancement module. The semantic segmentation takes place only along a context path in the AI image recognition system 300.

Initially, the output of the Enhancement module (Module 1) is downsampled quickly to obtain a sufficient receptive field. Then, upsampling occurs directly on the same context path after using an attention refinement module (ARM), shown as two blocks in this figure. The attention refinement module (ARM) encodes output features into vectors by global average pooling to capture global context, thus refining the output at each of various stages of downsampling along the Path. To this end, the attention refinement module (ARM) is configured to execute in the following sequence a global average pooling of downsampled image data, a 1×1 convolution operation, batch normalization, a sigmoid function, and a matrix multiplication function.

The convolutional neural network is thus configured to downsample image data in a series of downsampling processes, apply global average pooling at a tail end of the downsampling processes, and subsequently upsample only an output derived from the global pooling.

The size of the enhanced image input to the Detection module by the Enhancement module (Module 1) is relatively small. Thus, the present inventors have found that it becomes unnecessary to encode spatial information (information about the relative location and orientations of pairs of pixels) into the output of the Detection module to preserve accuracy in the results of the detection of objects by the module.

This embodiment of the present technology can be characterized as essentially consisting of local operations, namely convolutions, pooling, sampling. Thus, computational power is kept to a minimum.

ResNet architecture is used as the backbone to produce semantic edge maps. Here, the training provided by the ResNet architecture increases the effective receptive field.

There are many variants of ResNet architecture, but according to an embodiment of the present technology the Detection module is implemented using ResNet-18 (an 18-layer ResNet). The essential features of ResNet-18 architecture, for use in implementing the present embodiment, are shown in FIG. 7. This baseline architecture is known, per se, and the concepts behind it, such as the use of skip connections shown in the figure, are described in Deep Residual Learning for Image Recognition, He et al., arxiv.org/abs/1512.03385 (December 2015), the entire contents of which are hereby incorporated by reference. Therefore, such architecture will not be described herein in more detail.

### 3: Polygon Extraction

Objects of the same class in an image cannot be distinguished from each other using the semantic segmentation model/step provided in the Detection module. That is, the semantic segmentation model executed by the Detection module produces masks in which objects in the same class are not distinguished from each other.

The Polygon extraction module uses the segmentation masks produced in the semantic segmentation step to extract polygons which the capture the geometry of each discrete object in the image output by the Detection module. Therefore, in the algorithm executed by the Polygon extraction module, the edges of the objects are integrated with polygons to determine the type of surface anomaly.

To this end, the Polygon extraction module executes a border-following algorithm. In this process, polygons which bound the objects (surface anomalies) are extracted from the images, in contrast to bounding boxes used in more conventional object detection AI techniques. In an embodiment of the present technology, the GPU of the deep learning tool 310 is configured with a Suzuki contour algorithm to implement the Polygon extraction module. The algorithm can be programmed using Python provided in the popular OpenCV library under the topic heading, “Finding contours in your image”

### Programming in Python

(#Find contours, hierarchy=cv2.findCountours(binary mask, cv2.RETR_TREE, cv2.CHAIN_APPROX_SIMPLE)).

In the illustrated example, the polygon extraction process identifies the anomaly as a scratch along the surface of channel 114.

### 4: Tracking Module

Module 4 is a Tracking module (which may be referred to as a “tracker” hereinafter) that tracks results of the semantic segmentation and polygon extraction processes to identify unique objects in the video image data and maintain their trajectory in the stream of images constituting the video image data. In this way, the existence of discrete occurrences of a particular type of surface anomaly can be determined. In the illustrated example, whether the edges form one continuous scratch or more than one discrete scratch can be determined.

The Tracking module of the present technology is configured to execute a ByteTrack data association method for the pipeline of images processed by the modules 310b of the deep learning tool 310. Modern tracking models use a “tracking-by-detection” framework, which first uses a detection model to obtain the bounding boxes (bboxes) of objects, and then updates the tracker state based on the bboxes. In the Tracking module of an embodiment of the deep learning tool 310 according to the present technology, bboxes of polygons obtained in from the Polygon extraction module are used instead. The ByteTrack model accesses the bboxes as input, as well as confidence scores for each bbox that the Detection module produces. The semantic segmentation process performed by the Detection module predicts the probability (confidence score) for each pixel separately, so by default confidence scores are not derived for each object. Rather, the present technology takes the probability matrix of each class and crops inside each polygon of the object.

Then the average value of the probabilities inside the polygon are calculated, thus obtaining the confidence score for that particular object.

To this end, the ByteTrack-based tracker of the Tracking module combines a motion model with a Kalman Filter that manages a queue (tracklets) to store objects being tracked, and performs tracking and matching between bounding boxes with low confidence scores.

The Tracking Module of this example of the present technology also executes the following processes or subroutines:
1. Polygon adjustments.
2. Restoring polygons if for some reason the execution of the semantic segmentation process by the Detection module did not detect objects, i.e., surface anomalies present along the channel.
3. Extracting frames from the video image data in which different objects are present and generate reports.

### 5: Fusing

A fusion algorithm is executed on the output of the Tracking module to blend the output of the detection with the results of the Tracking module for the purpose of counting and keeping track of the type of individual objects (surface anomalies). In essence, Module 5 is designed to track objects over time in a video sequence. The algorithm uses the output bounding box from the object detector as an initialization and then refines it over subsequent frames based on the object's motion and appearance. This means that the output bounding box from the tracker may differ from the one that came from the object detector due to changes in the object's location, scale, or orientation over time. Therefore, it may be necessary to adjust the polygon of the object to match the bounding box from the tracker.

More specifically, the vertices of the polygon are adjusted to refine the polygon so that it fits within the bounding box. The polygon is scaled and translated to match the dimensions and position of the bounding box. A step-by-step approach follows:
1. Compute the minimum bounding box that encloses the polygon.
2. Compute the scaling and translation factors needed to map the minimum bounding box to the output bounding box from the tracker.
3. Apply the scaling and translation factors to each vertex of the polygon to obtain the refined polygon.

This increases the success rate of the deep learning tool 310 in recognizing and discriminating surface anomalies from one another.

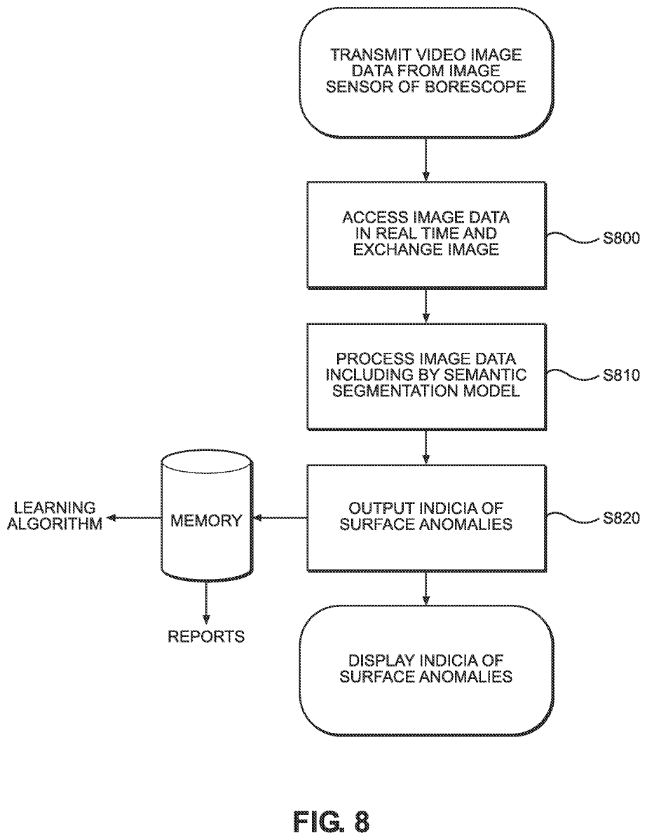

FIG. 8 shows an example of a method of detecting anomalies along a channel of a medical scope using the deep learning tool 310 shown in and described with reference to FIGS. 3-6.

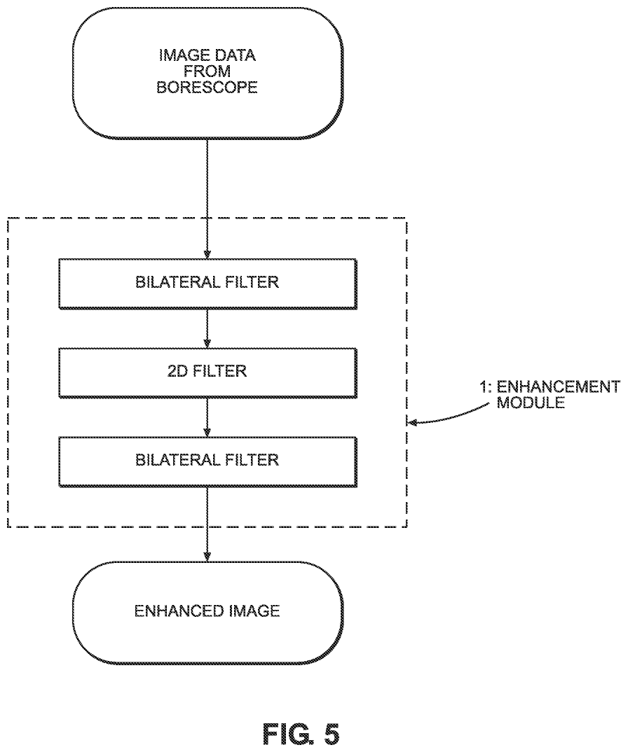

Referring to FIGS. 1-8, a technician pushes the digital borescope 200 through a working channel 114 of the medical scope 100. The (video RGB) image data produced from the pixels of the image sensor 214 of digital borescope 200 is sent along a network by which it is accessed in real time by deep learning tool 310. The deep learning tool 310 may also enhance the image data (1: Enhancement Module in FIGS. 4 and 5), i.e., in effect produce enhanced images of the standard definition images produced by the digital borescope 200. (S800)

The Detection module of the deep learning tool 310 has a convolutional neural network pre-trained on a data set of images of surface anomalies along channels of medical scopes like that through which the digital borescope 200 is pushed. And the convolutional neural network is configured for semantic segmentation, as exemplified by the flowchart and architecture shown in and described with reference to FIGS. 6A, 6B and 7. The image data is processed including by semantic segmentation only along a context path. Other processes include polygon extraction, tracker predictions and image fusion as respectively executed using the Suzuki contour algorithm, the Tracking module and the fusion algorithm shown in and described with reference to FIG. 4. (S810)

Indicia of surface anomalies along the length of the working channel 114 is output based on results of the processing (S820). For example, the indicia comprise data of surface anomalies, output by the Tracking module (FIG. 4) after having been subjected to the fusion algorithm, and can be used to generate graphics using the graphics output module 310c (FIG. 3). The data used for this purpose can also be stored in a memory and may be used to generate reports bearing on the inspection process, described in further detail below. Respective stored data may also be used to update the learning algorithm of the training module 310d (FIG. 3).

Due to essentially no spatial information of the pixels in the image data being encoded in the segmentation mask produced by the Detection module, the entire process can be executed at a rate of no more than about 30 frames per second to detect and recognize any of various predetermined types of surface anomalies along the surface of the working channel 114 with a high degree of reliability.

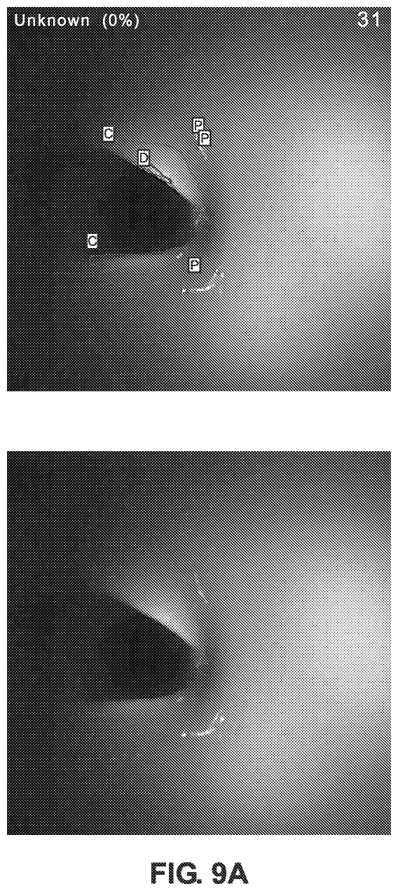

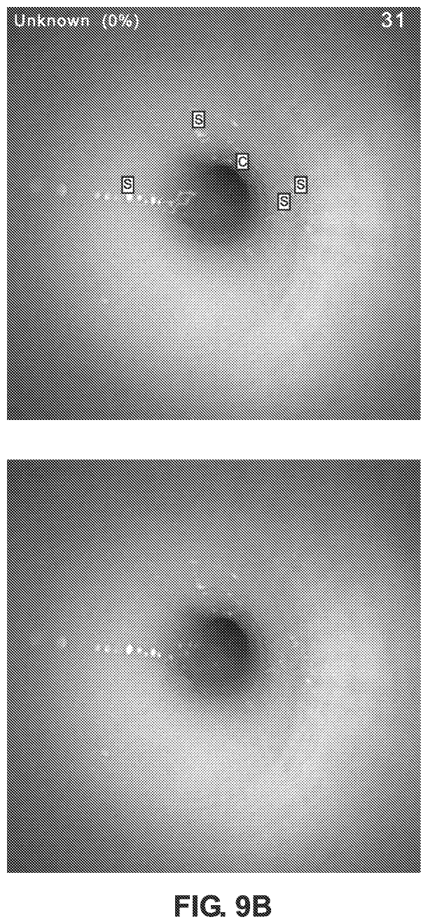

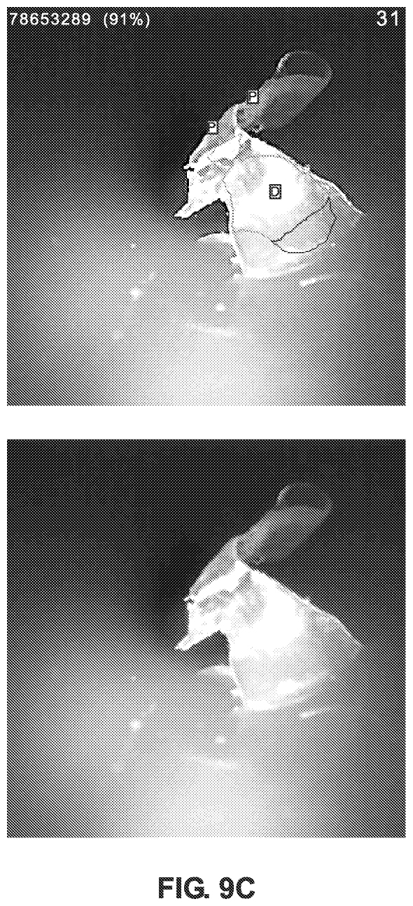

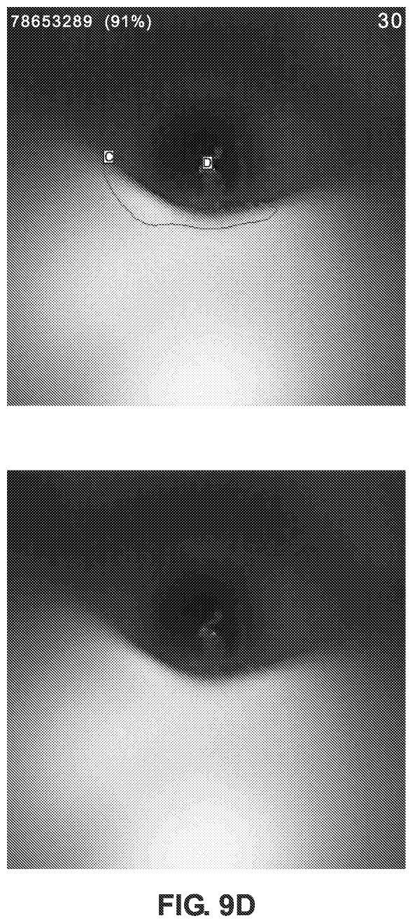

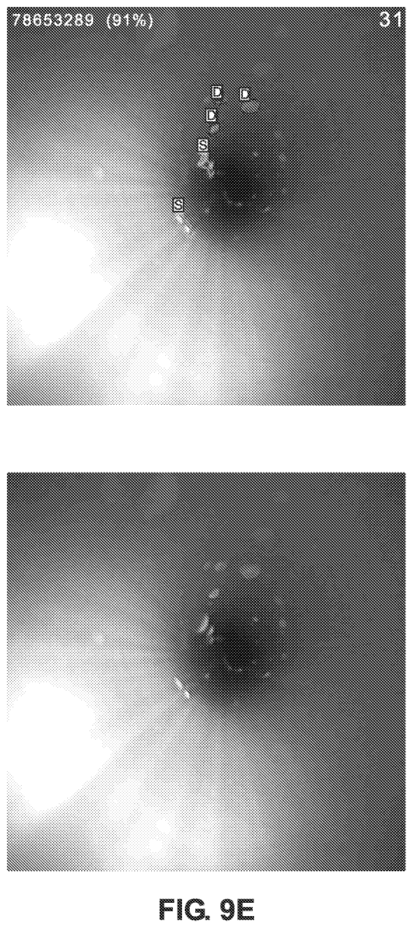

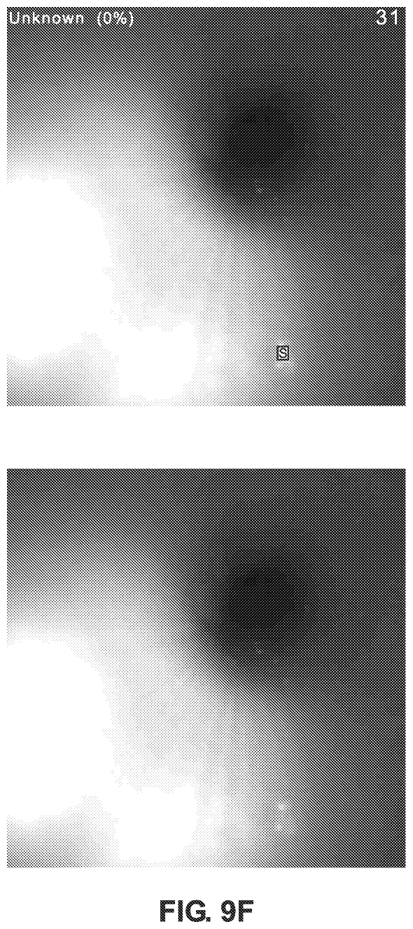

Thus, in what is essentially a time-neutral manner with respect to the outputting of images by the digital borescope 200, indicia of surface anomalies along the working channel 114 can be displayed on visual display unit 320 and reports can be automatically generated. The indicia may be in the form of enhanced images of the working channel 114 augmented with graphics overlaid on or near the surface anomalies (see FIGS. 9A and 9B and the description thereof below). The indicia may also comprise or consist of a table showing the instances and types of surface anomalies detected. Thus, the indicia may be analyzed by a technician to determine a course of action to be taken with respect to the medical scope, e.g., acceptable for use, to be re-processed or repaired, to be discarded as damaged beyond repair, etc.

The time neutrality referred to above can also apply to the performing of the following tasks. The output of the AI image recognition system 300 can be used to create a work flow by which usage of medical scopes tested is optimized, reducing turnover time associated with reprocessing. Indicators of foreign matter derived from the output, such as droplets, degree, organic matter, or brushes, can be used to score the cleaning process, such as the enzymatic cleaning process. Indicators of mechanical damage derived from the output, such as scratches, peeling, crimping, can be used to generate reports or emails associated with the repair process, such as emailing a department head for approval to take a medical scope out of service and send it off for repairs, or even emails to the repair service operator informing them of the nature and extent of necessary repairs. The same can be used to determine false positives or negatives and obviously, as referred to above, update the learning algorithm 310d. Because the detection and identification of surface anomalies occurs in real time with the attendant advantages of sensitivity and reliability regardless of the speed at which a borescope is pushed through the channel, these reports, emails, etc. can be generated in a time neutral manner.

FIGS. 9A-9F show samples of results of carrying out the method of FIG. 8 using the AI image recognitions system 300 (FIGS. 3-7) according to the present technology.

In the figures, the results that may be displayed on display 320 are the upper images in each figure, and the lower images show the corresponding images captured by the borescope 200 and accessed by the system as input. In this example, the indicia of the surface anomalies are provided as graphics overlayed on the processed images at the locations of the anomalies.

The graphics in this example include letter marks identifying the surface anomaly by class: “s” for scratch, “p” for peeling, “d” for droplet, “c” for crimp and so on, as well as enhanced outlines of the edge boundaries of the surface anomalies. Therefore, these lettermarks could readily be tabulated and displayed on the GUI of the visual display unit 320 in table form as further indicia of the surface anomalies.

As is clear from the description above, the present technology offers an enhancement of the speed at which AI object detection can take place at least in the context of detecting surface anomalies in medical scopes. Thus, the present technology can reduce labor costs associated with the inspection of channels of medical scopes, reduce downtime, facilitate protocols for repair etc. Furthermore, although the present technology has been described above in detail with respect to various embodiments and examples thereof, the technology may be embodied in many different forms to implement the present invention. Thus, the present invention should not be construed as being limited to the embodiments and their examples described above. Rather, these embodiments and examples were described so that this disclosure is thorough, complete, and fully conveys the present invention to those skilled in the art. Thus, the true spirit and scope of the present invention is not limited by the description above but by the following claims.

What is claimed is:

1. A method of detecting anomalies along a channel of a medical scope, the method comprising:
accessing, at an artificial intelligence (AI) image recognition system including a deep learning tool, image data produced by a digital borescope as the borescope is pushed along a length of a channel of a medical scope,
the digital borescope including an image sensor having a pixel array,
the deep learning tool having a convolutional neural network, the convolutional neural network configured for semantic segmentation along a context path, and the convolutional neural network being trained on a data set of images of surface anomalies along channels of medical scopes similar to that through which the borescope is pushed;
processing the image data produced from the pixels of the image sensor as the digital borescope is pushed through the channel of the medical scope to predict in real time the presence of one or more types of anomalies at locations along the length channel, the processing including semantic segmentation of the image data by the convolutional neural network, the semantic segmentation occurring along only a context path in the AI image recognition system once the image data is accessed by the system; and
outputting indicia of surface anomalies along the length of the channel based on results of the processing.

2. The method as claimed in claim 1, wherein the processing of the image data comprises downsampling image data in the deep learning tool in a series of downsampling processes, applying global average pooling at a tail end of the downsampling processes, and subsequently upsampling only output derived from the global pooling.

3. The method as claimed in claim 1, wherein the semantic segmentation assigns semantic labels to pixels outputting image data of edges of features along the channel, and the processing further includes:
a polygon extraction process that integrates the edges with polygons to produce data of the type of the surface anomaly,
a tracking process that tracks results of the semantic segmentation and polygon extraction processes between frames to discriminate surface anomalies from one another, and a tracker and detection fusion process that outputs data of numbers and type of surface anomalies.

4. The method as claimed in claim 1, wherein the outputting of indicia comprises overlaying graphics in real time on images of the channel having surfaces of anomalies.

5. The method as claimed in claim 4, wherein the processing further comprises enhancing the image data produced by the digital borescope before the semantic segmentation of the image data.

6. The method as claimed in claim 1, wherein the processing further comprises enhancing the image data produced by the digital borescope before the semantic segmentation of the image data.

7. The method as claimed in claim 1, wherein the processing is executed at a rate of no more than about 0.03 seconds per frame.

8. A method for use in evaluating medical scopes, the method comprising:
pushing a digital borescope, including an image sensor having a pixel array, along a length of the channel to capture images of the channel and output image data representative of the images;
transmitting image data from each of the pixels of the image sensor of the digital borescope to an artificial intelligence (AI) image recognition system including a deep learning tool configured to predict the presence of at least one type of anomaly at locations along the length channel of the medical scope, the deep learning tool having a convolutional neural network,
the convolutional neural network being trained on a data set of images of surface anomalies along channels of medical scopes similar to that through which the borescope is being pushed, and
the deep learning tool being configured for semantic segmentation and to process in real time image data produced from the pixels of the image sensor of the borescope, the semantic segmentation occurring along only a context path in the deep learning tool of the AI image recognition system once the image data is received by the system, and
the AI image recognition system being configured to output indicia of surface anomalies along the length of the channel based on results of the processing of the image data by the deep learning tool; and
analyzing the indicia of surface anomalies output by the image recognition system.

9. The method as claimed in claim 8, wherein the transmitting of image data from each of the pixels of the image sensor of the digital borescope comprises transmitting data of images in standard definition.

10. The method as claimed in claim 8, wherein the deep learning tool has modules configured to assign semantic labels to pixels outputting image data of edges of features along the channel, integrate the edges with polygons to produce data of the type of the surface anomaly, and track results of the semantic segmentation and polygon extraction processes between frames of the image data to discriminate surface anomalies from one another, and
the deep learning tool is configured with a fusing algorithm to output data of the types and numbers of surface anomalies from output of the modules.

11. The method as claimed in claim 8, wherein the deep learning tool has an image enhancement module configured to enhance the image data produced by the digital borescope before the semantic segmentation of the image data.

12. The method as claimed in claim 8, wherein the borescope is pushed manually through the channel of the medical scope.

13. An artificial intelligence (AI) image recognition system for use in detection of surface anomalies along a channel of a medical scope, the system comprising:
a video input output (I/O) operative to receive data of video images and output the data;
deep learning modules operatively connected to the video input output (I/O) to receive data of video images therefrom, and configured to process image data produced from an image sensor of a digital borescope, the deep learning modules including a convolutional neural network trained on a data set of images of surface anomalies present along a surface of channels of medical scopes, and the convolutional neural network being configured for semantic segmentation along only a context path once data of video images is output from the video I/O and received by the deep learning modules; and
a graphics output module including a video input output (I/O) operatively connected to the image processing modules to receive results of the processing of data of video images by the image processing modules and output the results.

14. The system as claimed in claim 13, wherein the convolutional neural network is configured to downsample image data in a series of downsampling processes, apply global average pooling at a tail end of the downsampling processes, and subsequently upsample only output derived from the global pooling.

15. The system as claimed in claim 13, wherein the image processing deep learning modules include:
an edge detection module configured to assign semantic labels to pixels outputting image data of edges of features along the channel,
a polygon extraction module configured with a contour algorithm to integrate the edges with polygons to produce data of the type of the surface anomaly, and
a tracking module configured to track results of the semantic segmentation and polygon extraction processes between image frames to discriminate surface anomalies from one another.

16. The system as claimed in claim 14, wherein the deep learning modules are configured with a fusing algorithm that processes a result of data output by the tracking module to output data of types and numbers of the surface anomalies.

17. The system as claimed in claim 13, further comprising a visual display unit integrated with the video I/O of the graphics output module to display the results.

18. The system as claimed in claim 13, wherein the graphics output module includes a graphics generator configured to generate indicia of surface anomalies along the length of the channel from a result derived from the semantic segmentation.

19. The system as claimed in claim 18, wherein the indicia comprise graphics overlayed on or adjacent to the surface anomalies in images of the channel.

20. The system as claimed in claim 13, wherein the deep learning modules are configured to process video image data at a rate of no more than about 0.03 seconds per frame.
